(19) United States
(12) Patent Application Publication
(10) Pub. No.: US 2010/0042623 A1
(43) Pub. Date: Feb. 18, 2010

(54) System and method for mining and tracking business documents

(76) Inventors: Junlan Feng, Basking Ridge, NJ (US); Valerie Torres, Bronx, NY (US)

Correspondence Address: AT & T LEGAL DEPARTMENT - Canavan, ATTN: PATENT DOCKETING, ROOM 2A-207, ONE AT & T WAY, BEDMINSTER, NJ, 07921, US

(21) Appl. No.: 12/228,551

(22) Filed: Aug. 14, 2008

(51) Int. Cl. G06F 7/06

(52) U.S. Cl. 707/6; 707/E17.127

(57) ABSTRACT

Systems and methods are described that mine and track archived business documents for discovering business knowledge and intelligence using data mining, machine learning, statistics, and computational linguistics, from different linguistic sources according to their meaning.

### BACKGROUND OF THE INVENTION

The invention relates generally to information retrieval. More specifically, the invention relates to systems and methods for business document mining using data mining, machine learning, statistics, and computational linguistics, from different linguistic sources according to their meaning.

Today, enterprises seek to discover the knowledge contained in their day-to-day business documents such as service agreements, product guides, customer care, and sales records. These documents are archived in a variety of formats including Microsoft Word, Excel, PowerPoint, Adobe Acrobat (pdf) and Postscript, HTML, and include both audio and video files.

Since most information is currently stored as text or can be transcribed into text, text mining has a high commercial value. There has been an increased interest in multilingual data mining, having the ability to gain information across languages.

What is desired is a system and method that derives high quality information from a plurality of different document types and formats to support business needs.

### SUMMARY OF THE INVENTION

The inventors have discovered that it would be desirable to have systems and methods that mine and track business documents for discovering business knowledge and intelligence, and structure and content changes.

Embodiments mine and track business documents that impact companies where information is continuously being generated, archived, and often remains unanalyzed for discovery of business knowledge and intelligence. Automated knowledge and intelligence discovery enhances business tasks that include customer care, strategizing, negotiation, and policy making. The embodiments enable enterprises to better understand their customer care, pricing, and sales documents. Embodiments include mining and tracking business email and web documents.

One aspect of the invention provides a method for mining and tracking documents. Methods according to this aspect of the invention include inputting a plurality of documents, converting the documents into a common data format, analyzing the structure and content of each document, organizing the documents into a series, mining each series for specific intelligence, and comparing documents in a series to determine disparities in structure and content.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is an exemplary system framework.

FIG. 2 is an exemplary method.

### DETAILED DESCRIPTION

Embodiments of the invention will be described with reference to the accompanying drawing figures wherein like numbers represent like elements throughout. Before embodiments of the invention are explained in detail, it is to be understood that the invention is not limited in its application to the details of the examples set forth in the following description or illustrated in the figures. The invention is capable of other embodiments and of being practiced or carried out in a variety of applications and in various ways. Also, it is to be understood that the phraseology and terminology used herein is for the purpose of description and should not be regarded as limiting. The use of “including,” “comprising,” or “having,” and variations thereof herein is meant to encompass the items listed thereafter and equivalents thereof as well as additional items.

The terms “connected” and “coupled” are used broadly and encompass both direct and indirect connecting, and coupling. Further, “connected” and “coupled” are not restricted to physical or mechanical connections or couplings.

It should be noted that the invention is not limited to any particular software language described or that is implied in the figures. One of ordinary skill in the art will understand that a variety of alternative software languages may be used for implementation of the invention. It should also be understood that some of the components and items are illustrated and described as if they were hardware elements, as is common practice within the art. However, one of ordinary skill in the art, and based on a reading of this detailed description, would understand that, in at least one embodiment, components in the method and system may be implemented in software or hardware.

By way of background, data mining is the process of applying computer-based methodology including techniques for knowledge discovery from data. Data mining identifies trends within data. Through the use of sophisticated methods, users may identify key attributes of business processes and target opportunities. Data mining often applies to the two separate processes of knowledge discovery and prediction. Knowledge discovery provides explicit information that has a readable form and can be understood by a user. Predictive modeling provides predictions of future events and may be transparent and readable in approaches using rule based, or expert systems, and opaque in others using neural networks.

The data in a given data set, or Metadata, is often in a condensed data-minable format, for example, pricing proposals and customer-agent conversations. Data mining relies on the use of real world data and is vulnerable to collinearity because it may have unknown interrelations. An unavoidable weakness of data mining is that the critical data that may explain the relationships is never observed.

Embodiments of the invention provide methods, system frameworks, and a computer-usable medium storing computer-readable instructions for mining and analyzing business documents for structure and content changes. The invention is a modular framework and is deployed as software as an application program tangibly embodied on a program storage device. The application code for execution can reside on a plurality of different types of computer readable media known to those skilled in the art.

The system frameworks and methods of the invention provide a single platform that analyzes many types and formats of business documents. The framework clusters business documents into categories such as pricing proposals, mines archived documents for embedded (hidden) business intelligence and knowledge, such as collecting features of pricing proposals and tracks them for success sales/failed sales, which can be tailored by domain experts such as salespeople and managers to more efficiently and effectively plan their policies and strategies of negotiation. Embodiments provide a search capability for diverse audiences such as managers and sales representatives to query through these documents and compare the documents in a statistical manner that tracks documents of interests for anomalies, trending, and pattern discovery.

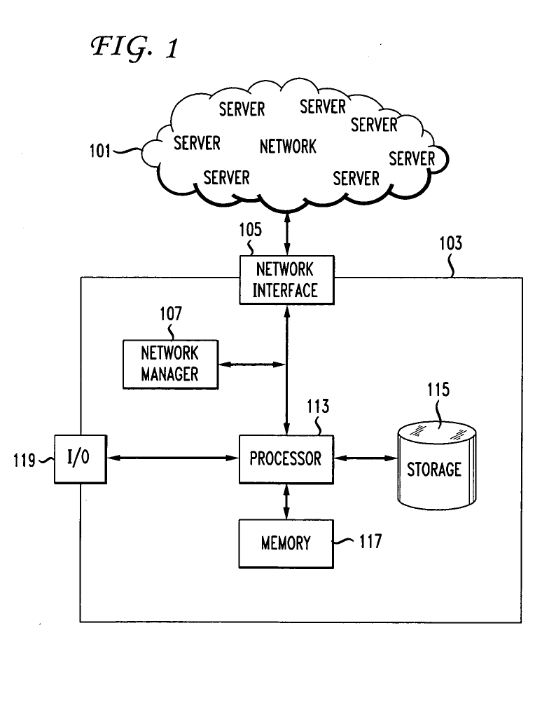

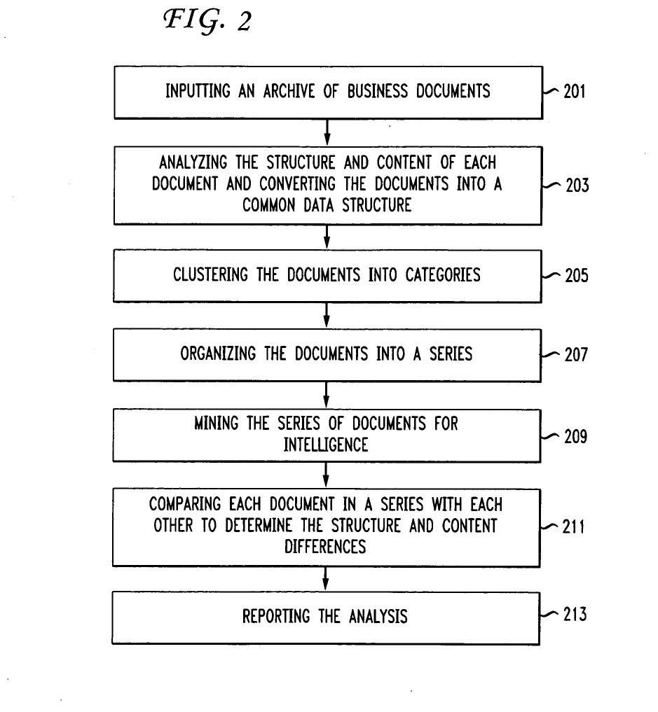

FIG. 1 shows an embodiment of a system 101 framework 103 and FIG. 2 shows a method. The framework 103 includes a network interface 105 that may be coupled to a network and configured to acquire documents of interest. Documents may be provided as a live feed-through network, stored on a file server, or scattered on many connected computers. If the documents are not explicitly provided by the user, the system will scan through an intranet network for targeted documents. Tracking is performed by collecting, monitoring, and mining data in a time series. Every document has a time attached. For instance, from customer-care documents such as emails and audio files, embodiments may trend how customer concerns change over a period of time (years or seasons). The network interface 105 is coupled to a network manager/inventory database 107 and a processor 113. The processor 113 is coupled to storage 115, memory 117 and I/O 119. The system framework 103 may also be deployed as cloud computing, where computation and storage may exist anywhere in the network, or in a plurality of networks. The architecture behind cloud computing is a massive network of interconnected cloud servers. Users may, or may not have full control of where data is stored and where the computation is actually conducted.

The framework 103 may be implemented as a computer including a processor 113, memory 117, storage devices 115, software and other components. The processor 113 is coupled to the network interface 105, I/O 119, storage 115 and memory 117 and controls the overall operation of the computer by executing instructions defining the configuration. The instructions may be stored in the storage device 115, for example, a magnetic disk, and loaded into the memory 117 when executing the configuration. The invention may be implemented as an application defined by the computer program instructions stored in the memory 117 and/or storage 115 and controlled by the processor 113 executing the computer program instructions. The computer also includes at least one network interface 105 coupled to and communicating with a network such as shown in FIG. 1 to interrogate and receive network configuration or alarm data. The I/O 119 allows for user interaction with the computer via peripheral devices such as a display, a keyboard, a pointing device, and others.

Embodiments parse business documents archived in multiple formats into a common data structure, such as XML, and perform further analysis based on this format. Further analysis comprises a redundancy check-up of documents, document consolidation, task-specific document clean-up, and others.

An archive of documents for various purposes such pricing proposals, technical reports, and others, which may be in different formats such as MS-word, pdf, etc., and located in storage or on a network or intranet, are input (step 201). Each document structure and content is analyzed during a basic document analysis. If the business documents are archived in a plurality of stored formats, they are converted into a common data format or structure, such as XML for further analysis (step 203).

Most web pages are encoded in HTML. Embodiments may use, for example, HTML Tidy to clean-up HTML pages. HTML Tidy comprises a program and a library that repairs invalid HTML and gives the source code a reasonable layout. HTML Tidy repairs missing or mismatched end tags, mixed-up tags, adds missing items, reports proprietary HTML extensions, changes layouts owing to predefined style, transforms characters from some encodings into HTML entities, and cleans-up presentational markup. For web documents retrieved that are not in HTML, such as Microsoft Word, PowerPoint and Adobe pdf, a third party software tool may be used to convert them to HTML or text files.

An HTML document has two types of structures, a Document Object Model (DOM) tree structure of the source code and a layout of the rendered page. Embodiments perform two steps. First, the DOM tree is parsed based on HTML source codes into a table representation where each row corresponds to a leaf node sequentially from left to right on the tree, and columns corresponds to the HTML tag of the associated leaf node, the parent tag path, and the visual, geometric, or functional attributes of this node. The conversion process is reversible, the same web page can be regenerated from the table. This representation serves as a base for web page layout decoding.

The DOM is a platform and language independent standard object model for representing HTML or XML and related formats. A web browser is not obliged to use DOM in order to render an HTML document. However, the DOM is required by JavaScript scripts that wish to inspect or modify a web page dynamically. The DOM is the way JavaScript sees its containing HTML page and browser state. Because the DOM supports navigation in any direction (e.g., parent and previous sibling) and allows for arbitrary modifications, an implementation may buffer the document that has been read or some parsed form of it.

Second, parsing discovers the layout of a web page. Most web pages have a specific layout. For example, a news web page may comprise a variety of advertisements at the top of the page, a vertical menu on the left, a heading of the news article, the body of the piece of news, as well as a footnote. Parsing formulates web page layouts as a task involving web page segmentation, where a web page is segmented into smaller information blocks, and information block classification, where the semantic categories of the smaller information blocks are identified. An information block is defined as a coherent topic area according to its content or a coherent functional area according to its associated behavior.

Top-level document clustering clusters documents into categories, such as pricing proposals or technical reports, according to document similarity (step 205). Embodiments cluster documents into categories using machine learning and statistical learning techniques, and extracts features such as content features, structure features, and metadata features of a document.

A cluster provides a method to drill down from trending graphics or reports to supporting documents. However, one problem is that many top supporting documents produced by a search describe similar stories about the searched terms. Cluster search performs a classic search first. The method clusters the returned documents D into groups of documents. Documents in a group are considered similar in terms of stories about the given query. For instance, if two pages have “iPhone unlock” as one of the menu items on the pages, but the main body of the two pages are very different. Therefore, these two documents are not similar in general. However, they are similar in terms of context—iphone. One does not provide any new information about iPhone that the other includes. This is the goal behind clustering.

The features may be predetermined by the customer, or automatically selected by the mining program. Embodiments examine all possible features, and select those features exhibiting statistically significance such as a text string, a continuous numeric value, a binary value, and discrete values. The features are input to supervised or unsupervised learning approaches such as a support vector machine, maximum entropy, and/or a Bayes classifier.

Supervised learning labels documents as the training data to learn a clustering model. Unsupervised learning assumes nothing is given.

Supervised learning is a machine learning technique for learning a function from training data. The training data consist of pairs of input objects typically vectors, and desired outputs. The output of the function can be a continuous value referred to as regression, or can predict a class label of the input object, referred to as classification. The task of supervised learning is to predict the value of the function for any valid input object after having seen a number of training examples, for example, pairs of input and target output. To achieve this, supervised learning has to generalize from the presented data to unseen situations in a “reasonable” way.

Unsupervised learning is a machine learning technique where manual labels of inputs are not used. It is distinguished from supervised learning which learn how to perform a task, such as classification or regression, using a set of human prepared examples. Clustering is one form of unsupervised learning which is sometimes not probabilistic. Adaptive resonance allows the number of clusters to vary with problem size and lets a user control the degree of similarity between members of the same clusters by means of a user-defined constant referred to as the vigilance parameter. Documents are clustered into groups according to their mutual similarity.

The clustered documents are organized into a time series. For example, putting pricing proposals for a given product into a time series if the applicable documents have time information. Documents in a time series have the same topic and purpose (step 207).

Semantic categories may be application oriented or generic. For example, parsing a news web page may only be interested in four categories of information blocks such as the news heading, the date, the body of the news articles, and the authors. For a generic case, twelve semantic categories are defined for classifying web page information blocks and comprise Page-Title, Form, Table-Data, FAQ-Answer, Menu, Bulletined-List, Heading, Heading-List, Normal-Content, Heading-Content, and Picture-Label.

Embodiments use machine learning, such as support vector machines, for use as a binary classifier to detect boundaries between information blocks and as a multi-class classifier of semantic category classification. The training data consists of example web pages manually labeled with targeted information categories. Embodiments convert other formats of documents into HTML. Every type of document has a layout and content, and HTML is one encoding mechanism that encodes both.

Mining is used to obtain intelligence from a series of documents (step 209). Documents are compared and disparities in structure and content are extracted (step 211). The changes are summarized as a statistical view and presented as reports (step 213). A user may drill down from high level information to the final details.

The specific mining purposes may be tailored to specific needs. For instance, language changes in these documents may be shown over time. The changes may be plotted for a number of documents for a certain product over a given period to show what was the hot topic, how prices changed during a bargaining process, common features of successful sales, detecting templates between documents, and others.

Embodiments mine archived documents for embedded (hidden) business knowledge. Website mining extracts structured information, such as contact information (e.g., phone numbers, email addresses, mailing addresses, and URLs), organization names, acronyms, and names and salient features of products and services for a company website. For a specific application, the structured information types may be customized by providing examples or rules.

An external translation software tool such as Systran may be used in the search to enable analysts to query in English and to search through multilingual documents. Lucene may be used as the underlying indexing and retrieval engine. Lucene may be augmented with indexing and retrieval with text normalization. Text normalization considers stemming and synonyms when indexing documents and parsing queries. Stemming refers to the process of mapping a word to its root form when tokenizing documents and queries. The motivation is that a user searching for “meetings”, for example, is also interested in documents containing the word “meeting”. The other advantage of stemming is reducing the language complexity. The number of distinct terms is dramatically reduced after stemming. Synonym search brings the search one level closer to semantic search. For instance, a user may type “˜meeting” to find pages containing “meeting”, “conference”, and “netmeeting”.

Prior to indexing, the textual content of information blocks is segmented into sentences and each sentence parsed with syntactic tags such as Named Entity (NE) tags and part-of-speech tags. A feature is semantic search as an option for analysts.

Semantic search extends the query to a semantic network centered on the input keywords based on WordNet. WordNet is a large lexical database of English. Semantically and syntactically related words are interlinked through a set of relationships. WordNet is used as a resource to suggest keyword expansions. A user may choose the breadth of this expansion for better search coverage. For instance, a query for “disease” will be extended to a number of disease names such as “flu”. Analysts may pick extended keywords to expand the original query. This feature improves analysts' productivity during investigation.

Trend search may be used to return various statistical views of the relevant data for comparison and trend catching. Analysts may use this tool to observe trends of events of their particular interest, discover anomalies, and to drill down to supporting web pages.

Embodiments provide a search capability based on the document analysis.

An enhanced multilingual search is employed for tracking. The basic search allows diverse audiences to query through the collected information generated by mining. A search can be configured by users to return relevant pages, information blocks, relevant phone numbers or products and services. A search may also output numeric data such as the frequency of a given keyword query and the number of new hyperlinks for a particular website on in a specific time frame. The search results and mined intelligence may be displayed using visualization tools.

One or more embodiments of the present invention have been described. Nevertheless, it will be understood that various modifications may be made without departing from the spirit and scope of the invention. Accordingly, other embodiments are within the scope of the following claims.

What is claimed is:

1. A method for mining and tracking documents comprising:
inputting a plurality of documents;
converting the documents into a common data format;
analyzing the structure and content of each document;
organizing the documents into a series;
mining each series for specific intelligence; and
comparing documents in a series to determine disparities in structure and content.

2. The method according to claim 1 wherein the inputted documents are in formats such as MS-word, pdf, HTML, and audio and video files.

3. The method according to claim 1 wherein the common data format is XML.

4. The method according to claim 1 wherein organizing the analyzed documents is in the form of document clustering.

5. The method according to claim 1 wherein a series further comprises a time series.

6. The method according to claim 1 wherein the structure and content differences include changes in the documents over time, the number of documents for a certain product in a given period, the hot topic in a given period of time, price changes in a bargaining process, common features of successful sales, and detecting templates between documents.

7. The method according to claim 3 further comprises cleaning-up HTML documents.

8. The method according to claim 7 further comprising:
parsing an HTML document into a Document Object Model (DOM) tree structure of the source code; and
laying out a rendered page.

9. The method according to claim 4 wherein document clustering clusters documents into categories according to document similarity.

10. The method according to claim 9 wherein document clustering is performed using machine learning and statistical learning techniques, and extracts features such as content features, structure features, and metadata features of a document.

11. A system for mining and tracking documents comprising:
means for inputting a plurality of documents;
means for converting the documents into a common data format;
means for analyzing the structure and content of each document;
means for organizing the documents into a series;
means for mining each series for specific intelligence; and
means for comparing documents in a series to determine disparities in structure and content.

12. The system according to claim 11 wherein the inputted documents are in formats such as MS-word, pdf, HTML, and audio and video files.

13. The system according to claim 11 wherein the common data format is XML.

14. The system according to claim 11 wherein means for organizing the analyzed documents is in the form of document clustering.

15. The system according to claim 11 wherein a series further comprises a time series.

16. The system according to claim 11 wherein the structure and content differences include changes in the documents over time, the number of documents for a certain product in a given period, the hot topic in a given period of time, price changes in a bargaining process, common features of successful sales, and detecting templates between documents.

17. The system according to claim 13 further comprises means for cleaning-up HTML documents.

18. The system according to claim 17 further comprising:
means for parsing an HTML document into a Document Object Model (DOM) tree structure of the source code; and
means for laying out a rendered page.

19. The system according to claim 14 wherein means for document clustering clusters documents into categories according to document similarity.

20. The system according to claim 19 wherein means for document clustering is performed using machine learning and statistical learning techniques, and extracts features such as content features, structure features, and metadata features of a document.
